(19) United States
(12) Patent Application Publication
(10) Pub. No.: US 2008/0311413 A1
(43) Pub. Date: Dec. 18, 2008

(54) Insulation Coating Composition for electrical steel

(76) Inventors: Frank-Rainer Boehm, Odenthal (DE); Barbara Froschauer, Gumpoldskirchen (AT); Reinhard Wallner, Weigelsdorf (AT); Nicolas van Zijl, Duesseldorf (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/156,866

(22) Filed: Jun. 5, 2008

Related U.S. Application Data
(60) Provisional application No. 60/934,304, filed on Jun. 12, 2007.

(51) Int. Cl. B32B 15/08; B05D 3/02; C08L 75/04; C08L 33/06; C08K 3/34; B23K 9/00

(52) U.S. Cl. 428/457; 427/388.2; 524/589; 524/560; 524/493; 524/413; 524/430; 219/137 R

(57) ABSTRACT

The invention provides a coating composition to coat electrical steel sheets, the composition comprising:

A) 5 to 45 weight % of at least one binder resin,

B) 0.1 to 40, preferably 1 to 30 weight % of nano scaled particles, the particles having an average radius ranging from 1 to 300 nm,

C) at least one cross-linking agent in an amount able to cross-link with the binder resin, preferably 0.1 to 30 weight % of at least one cross-linking agent,

D) 0.1 to 60 weight % of at least one additive and/or pigment and/or filler, and

E) 5 to 70 weight % of water and/or at least one solvent,

the weight % based on the total weight of the composition.

The composition according to the invention makes it possible to provide a high property profile standard combining the different technical requirements such as high ability for welding, clamping, interlocking, punching, riveting, high pressure, thermal resistance of electrical steel sheets coated with the composition according to the invention and of cores produced from these coated electrical steel sheets.

### CROSS REFERENCE TO RELATED APPLICATIONS

This application claims the benefit of U.S. Provisional Application Ser. No. 60/934304 filed on Jun. 12, 2007 which is hereby incorporated by reference.

### FIELD OF THE INVENTION

The invention relates to a universal core sheets varnish to coat electrical steel sheets for the production of steel sheets cores for use in electrical equipment to limit hysteresis and eddy current losses by improving the insulation properties.

### BACKGROUND OF THE INVENTION

Electrical steel sheet varnishes to coat individual electrical steel sheets are known. The coated electrical steel sheets can be assembled together by different technical means such as welding, clamping, interlocking, aluminium die casting or riveting to form a solid core for the use in electrical equipment, such as transformers, generators and motors. The coatings provide electrical insulation between the metal sheets in core and should be able to meet the requirements of high surface insulation resistance, resistance to mechanical stress and bonding strength.

JP-A 0733696, JP-A 2000345360 and EP-A 923 088 relate to enamels for coating electrical steel sheets wherein the enamels contain particles, such as, silica or alumina colloid particles. The compositions result in coatings having properties, such as good scratch, blocking, chemical and corrosion resistance and surface insulation ability. Patents relate to inorganic/organic coating for non-oriented electrical steels are EP-A 926 249 disclosing aluminium phosphate and inorganic particulate silicate and acrylic resins. DE-A 3720217 describes an insulation coating based on alkyd phenol modified polyester resin with sodium borate and pyrogenous silica providing insulation, punching and welding properties. JP-A 10130859 discloses a treating solution comprising colloidal silica providing a low-temperature and short-time baking for the production of non-oriented silicon steel sheets.

In WO 2006/049935, the use of reactive particles in a self-bonding varnish is described to provide coated metal sheets which can be bonded together by hot pressing, and which provide a high re-softening temperature. This self-bonding varnish cannot be used to coat the steel sheets and to form them together by, e.g. welding, clamping, interlocking, or riveting to form a solid core due to their different coating properties.

There exist coating systems known for the coating of electrical steel sheets suitable for e.g. welding or punching application to form a solid core. In view of this the core sheet varnish selection is frequently a compromise since there are occasions when a single coating will not fulfil all requirements. The known ranking classes of such coatings, for example class C3, class C5, and class C6 (registered as standards under AISI-ASTM A 976-03) show the different requirements of coatings in this field with regard to such properties. The coating may be only an organic mixture (C3 insulation type) or an organic/inorganic mixture of complex resins and chromate, phosphate and oxides (C5 and C6 insulation type).

C3 coatings based on organic resins, e.g. phenol, alkyd, acrylic and epoxy resin will enhance punchability and is resistant to normal operating temperatures but does not withstand stress-relief annealing. The C5 coating can be on the one hand a semi organic coating with very good punchability and good welding response and on the other hand a basically inorganic coating with organic resins and inorganic fillers, which has excellent welding and heat-resistance properties with good punchability. But C5 coatings generally based on chromate-, phosphate- or on titanate-compounds and are, therefore, not environmental friendly, particularly with respect to the remaining carcinogenic level of Cr(VI), or they can tend to hygroscopicitiy and insufficient annealing and corrosion resistance and can show insufficient welding properties. C6 coatings are organic coatings with a high content of fillers approximately of 50 wt %.

The known systems are not able to combine different technical requirements such as welding, clamping, interlocking, punching, riveting, pressure resistance and thermal resistance to provide a high property profile standard.

### SUMMARY OF THE INVENTION

This invention provides a coating composition to coat electrical steel sheets, the composition comprising:
A) 5 to 45 weight % of at least one binder resin,
B) 0.1 to 40, preferably 1 to 30 weight % of nano scaled particles, the particles having an average radius ranging from 1 to 300 nm,
C) at least one cross-linking agent in an amount able to cross-link with the binder resin, preferably 0.1 to 30 weight % of at least one cross-linking agent,
D) 0.1 to 60 weight % of at least one additive and/or pigment and/or filler, and
E) 5 to 70 weight % of water and/or at least one solvent, the weight % based on the total weight of the composition.

The composition according to the invention makes it possible to provide a high property profile standard combining the different technical requirements such as high ability for welding, clamping, interlocking, punching, riveting, high pressure, thermal resistance of electrical steel sheets coated with the composition according to the invention and of cores produced from these coated electrical steel sheets. The requirements for good corrosion resistance, also with regard to very thin coating layers in the range of below 1 μm, as well as excellent overcoatability of the coatings are fulfilled. The composition of the invention completes the performance of the varnishes which meet the C3, C5 and C6 insulation classes according to the AISI-ASTM A 976-03 standards. The invention provides excellent edge coverage and excellent punchability according to the C3-, C5- and C6 insulation classes, in particular, a very good pressure resistance, low stack shrinkage and a high insulation capacity at a film dry thickness of 6 to 12 μm according to C6-insulation coating. Furthermore it provides an excellent weldability and surface insulation resistance after stress annealing at a film dry thickness of up to 0.8 to 2 μm according to C5 insulation coating, and it offers a high abrasion resistance of the coatings.

### DETAILED DESCRIPTION OF THE INVENTION

The composition according to the invention is possible to apply as water-based coating composition with low VOC range.

As component A) one or more binder resins known in the coating art can be used in a range of 5 to 45 weight %, preferred in a range of 10 to 40 weight %, particularly preferred in a range of 15 to 35 weight %, based on the total weight of the composition according to the invention.

Examples of the resins are polyurethanes, polyamides, polyamide-imides, polyesters, unsaturated polyesters, polyimides, polyvinylformales, polyvinyl alcohols, C═C-reactive resins, polyhydantoines, polybenzimidazoles, alkyd resins, epoxy resins, poly(meth)acrylates, polytitanester resins.

Preferred is the use of polyurethanes and poly(meth)acrylates.

The term “(meth)acryl” stands for the meaning of “acryl” and “methacryl”.

For example, as component A) a polyurethane resin, for example an aliphatic polyurethane resin, can be used having an acid value (mg KOH/g solid resin) in the range of 28 to 33 and a hydroxyl value (mg KOH/g solid resin) in the range of 140 to 170. The average molar mass Mn of the polyurethane resin can be, for example from 2000 to 25000.

The production of the resins of component A) is known from the specialist literature.

The resin of component A) can also be at least one self cross-linkable resin, such as, e.g., epoxy novolak resin, as well as the known epoxy hybrid resin, for example, urethane-modified epoxy resin, acryl-modified epoxy resin and epoxy ester.

The resin of component A) can be introduced into the coating composition according to the invention as aqueous dispersion. Therefore, water can be added, for example in a quantity such that a solid content of 8 to 40 weight %, preferred 10 to 35 weight % of the aqueous dispersion of the resin of component A) is obtained. The production of, for example, a polyurethane dispersion is known from the literature, for example, Ullmann's Encyclopedia of Industrial Chemistry, A 21, page 665, VCH Verlagsgesellschaft Weinheim, 1992, and in patent applications, for example, DE-A1495745, DE-A 1495847.

As component B) 0.1 to 40 weight %, preferred 1 to 30 weight %, partularly preferred 3 to 25 weight % of nano scaled particles are used, based on the total weight of the composition according to the invention.

The nano scaled particles can be reactive particles and/or non-reactive particles. The term “reactive” means reactive with the functional groups of the binder resins of component A) and/or further components of the composition of the invention.

The reactive nano scaled particles can be based on an element-oxygen network, wherein the elements are selected from the group consisting of silicon, aluminium, zinc, tin, boron, germanium, gallium, lead, the transition metals, the lanthanides and actinides, particularly of the series comprising titanium, cerium and/or zirconium. The surface reactive functional groups R¹ and non-reactive or partly reactive functional groups R² and R³ are bonded by means of oxygen network, where R¹ is in the amount up to 98 wt. %, preferably, to 40 wt. %, particularly preferred, to 30 wt. %, R² and R³ are in the amount from 0 to 97 wt. %, preferably, 0 to 40, particularly preferred, 0 to 10 wt. % present on the surface of reactive particles, R¹ stand for radicals of metal acid esters containing R4, as, for example, OTi(OR⁴)₃, OZr(OR⁴)₃, OSi(OR⁴)₃, OSi(R⁴)₃; OHf(OR⁴)₃; NCO; urethane-, epoxy, carbon acid anhydride; C═C-double bonding systems as, for example, methacrylate, acrylate; OH; oxygen bonded alcohols, for example, bis(1-hydroxymethyl-propane)-1-methylolate, 2,2-Bis-(hydroxymethyl)-1-propanol-3-propanolate, 2-hydroxy-propane-1-ol-3-olate, esters, ethers, for example, 2-hydroxyethanolate, C₂H₄OH, diethylenglykolate, C₂H₄OC₂H₄OH, triethylenglykolate, C₂H₄OC₂H₄OC₂H₄OH; chelate builders, for example, aminotriethanolate, aminodiethanolate, acetylacetonate, ethylacetoacetate, lactate; COOH; NH₂; NHR⁴; and/or esters, reactive binders, as, for example, OH—, SH—, COOH—, NCO—, blocked NCO—, NH₂—, epoxy-, carbon acid anhydride-, C═C—, metal acid ester-, silane-containing polyurethane, polyester, poly(THEIC)ester, poly(THEIC)esterimide, polyamidimide, polyamide, polysiloxane, polysulfide, polyvinylformale, polymerisate, for example, polyacrylate. R² stands for radicals of aromatic compounds, for example, phenyl, cresyl, nonylphenyl, aliphatic compounds, for example, branched, linear, saturated, unsaturated alkyl rests C1 to C30, fatty acids derivatives; linear or branched esters and/or ethers, R³ stands for resin radicals, for example, polyurethane-, polyester-, polyesterimide-, THEIC-polyesterimide-, polytitanester resins and their derivatives; polysiloxane resin with organic derivatives; polysulfide-, polyamide-, polyamidimide-, polyvinylformale resin, and/or polymers, as, for example, polyacrylate, polyhydantoine, polybenzimidazole, and R⁴ stands for radicals of acrylate, phenol, melamine, polyurethane, polyester, polyesterimide, polysulfide, epoxy, polyamide, polyvinylformal resins; aromatic compounds, for example phenyl, cresyl, nonylphenyl; aliphatic, for example, branched, linear, saturated, unsaturated alkyl rests with C1 to C30; esters; ethers, for example, methylglykolat, methyldiglykolat, ethylglykolat, butyldiglykolat, diethylenglykolat, triethylenglykolat; alcoholate, for example, 1-hydroxymethyl-propane-1,1-dimethylolate, 2,2-Bis-(hydroxymethyl)-1,3-propandiolate, 2-hydroxy-propane-1,3-diolate, ethylenglykolate, neopentylglykolate, hexandiolate, butandiolate; fats, for example, dehydrated caster oil and/or chelate builder, for example, aminotriethanolate, aminodiethanolate, acetylacetonate, ethylacetoacetate, lactate.

The preparation of such particles may take place by conventional hydrolysis and condensation reactions of appropriate element-organic or element-halogen compounds and flame pyrolysis. Similarly, an organic resin may be reacted with corresponding element-oxide compounds to the corresponding reactive particle. A surface treatment can be carried out during the particle formation or after particle formation. Such methods of preparation are described in the literature. (See, e.g. R. K. Iler, John Wiley and Sons, “The Chemistry of Silica”, New York, page 312, 1979).

Examples of suitable reactive nano scaled particles are Aerosil products from Degussa AG, for example, Aerosil® R 100-8000, Eka Chemie (Bindzi®CC Nano-Silicasole).

As component B) also non-reactive nano scaled particles can be used, wherein said particles are based on an element-oxygen network, wherein the elements are selected from the group consisting of silicon, aluminium, zinc, tin, boron, germanium, gallium, lead, the transition metals, the lanthanides and actinides, particularly of the series comprising titanium, cerium and/or zirconium without any functional group which are able to make the particles reactive. Usable particles are, e.g., colloidal solution or dispersions of such particles, like silica, aluminum oxide, titanium oxide, preferably, colloidal silica, which are commercial available from, e.g., Nyacol® Corp., Grace Davison (Ludox® colloidal silica in water), Nissan Chemical.

The nano scaled particles of component B) have an average radius ranging from 1 to 300 nm, preferably, from 2 to 100 nm, particularly preferred, from 5 to 60 nm.

The nano particles can be introduced into the coating composition according to the invention as aqueous dispersion. Therefore, water can be added, for example in a quantity such that a solids content of 20 to 40 weight %, preferred 35 to 40 weight %, of the aqueous dispersion of the nano scaled particles is obtained.

Depending on component A) crosslinking agents can be used as component C) in an amount able to cross-link with component A), for example, in a quantity of 0.1 to 30 weight %, preferably 0.5 to 20 weight %, particularly preferred 1 to 15 weight %, based on the total weight of the composition according to the invention. Examples are water-soluble or water-miscible amino resins, for example, melamine formaldehyde resins, for example fully or partially methylated, blocked polyisocyanates, epoxy resins, polycarbodiimides, polyfunctional aziridines, carboxylic acids and/or the anhydrides, Lewis acid, organo-metallic catalysts.

Melamine formaldehyde resins, preferably a methylated melamine formaldehyde with a medium to high degree of alkylation, a low methylol content and medium to high imino functionality is usable as component C). The particle size of melamine resin can be, for example, preferably no greater than 10 μm, particulatly no greater than 2 μm.

The Melamine formaldehyde resins are described for example in Römpp Lexikon Lacke und Druckfarben, Georg Thieme Verlag 1998, page 29, “Amino Resins” and in Stoye/Freitag “Lackharze” Carl Hanser Verlag München Wien, 1996, pages 113-122. Examples of commercial products are Luwipal® (BASF AG) and Cymel® (Cytec).

Blocked isocyanate can also be used in the composition according to the invention as component C). Diisocyanates conventionally used in polyurethane chemistry can be used as the isocyanates, such as, adductes of polyols, amines and/or CH-acid compounds with diisocyanates. These include, for example, hexamethylene diisocyanate, isophorone diisocyanate, 2,4-(2,6)-toluylene diisocyanate, dicyclohexyl diisocyanate, 4,4-diphenylmethane diisocyanate (MDI). Derivatives of MDI, such as, isomers, homologs or prepolymers, such as, for example, Desmodur PF®, can also be used. 4,4-diphenylmethane diisocyanate is used in preference.

Blocking of the isocyanates can be achieved by conventional means, as known at a person skilled in the art, with, e.g., phenols or cresols, for example, with butanone oxime, phenol, 4-hydroxybenzoic acid methylester, ethanoic acid ester, malonic acid ester, dimethyl pyrazole and/or caprolactame. While caprolactame is used in preference, combinations from several of the mentioned compounds are also possible. The mechanism of reaction with polyurethan and/or acrylat dispersion with blocked isocyanates is described in H. Kittel Lehrbuch der Lacke und Beschichtungen, vol. 3, S. Hirzel Verlag Stuttgart, Leipzig 2001, second edition, page 230-234. Examples of commercial blocked isocyantes products for waterborne systems are Rhodocoat WT® (Rhodia Coatis) and Trixene® (Baxenden, Chemicals Limited).

The epoxy resin as component C) is preferably used as an aliphatic multifunctional epoxy resin originated from epichlorhydrin derivate. The triglycidyl ether of multifunctional alcohols e.g. glycerine, sorbitol and phenole can be used. Furthermore, epoxy resin containing isocyanate structure, e.g. triglycidylisocyanurate, can be used. The mechanism of cross-linking is described in H. Kittel, Lehrbuch der Lacke und Beschichtungen, vol. 3, S. Hirzel Verlag Stuttgart, Leipzig 2001, second edition, page 235-236.

Polycarbodiimides are also effective cross-linkers as component C). The mechanism is described in G. Doleschall and K. Lempert, On the Mechanism of Carboxyl Condensation by Carbodiimides, Tetrahedron Letters No. 18, pages 1195-1199, 1963 pergamon press ltd., and furthermore in W. Posthumus, A. J. Derksen, J. A. M van den Goorberg, L. C. J. Hesselmans, Crosslinking by polycarbodiimides, Progress in Organic Coatings 58(2007) pages 231-236.

Polyfunctional aziridines, for example, polyfunctional aziridine propionate, can also be used as component C). An overview of aziridine propionates can be found in R. R. Roesler, K. Danielmeier, Progress in Organic Coatings 50(2004), pages 1-27. Mechanism of cross-linking is described in H. Kittel, Lehrbuch der Lacke und Beschichtungen, vol. 3, S. Hirzel Verlag Stuttgart, Leipzig 2001, second edition, pages 242-243. Examples of commercial products are CX-100 from Avecia Resin, Xama® from Bayer.

Carboxylic acids and/or anhydrides can also be used as component C). These can be aliphatic, aromatic branched and un-branched carboxylic acids and/or the esters and/or the anhydrides, e.g., formic acid, acetic acid, valeric acid, caproic acid, isobutyric acid, pivalic acid, isovaleric acid, trimellitic acid, pyromellitic acid, naphthalic acid, the esters and the anhydrides.

Organo-metallic catalysts, such as e.g. titanate or zirkonate, based on titanium chelates or zirconium chelates, can also be used as component C). Organo-metallic catalysts cross-link under exchange of functional groups on the polymer. Commercial products are Titanates Tyzor® and Zirconates Tyzor® from DuPont.

The addition of additives as component D), such as, for example, levelling agents, flow agents, catalysts, for example Lewis acids, non-ionic and ionic surfactants and slip additives, as well as pigments and/or fillers, known at a person skilled in the art, in a quantity of 0.1 to 60 weight %, in case of additives preferred in a range of 0.1 to 10 weight %, based on the total weight of the composition according to the invention, makes it possible to optimize the coating system with regard to the quality of the coating, such as, for example, surface application, increasing stoving velocity or imparting colour.

Water and/or organic solvents may be used as component E) in the composition of the invention, in the range of 5 to 70 weight %, preferred in the range of 20 to 60 weight %, based on the total weight of the composition according to the invention. The use of water, only, is preferred.

Water is added, for example in a quantity such that a solids content of 20 to 50 weight %, preferred 30 to 70 weight %, of the finished coating composition according to the invention is obtained.

Organic solvents can be added in the range of 1 to 10 weight %, preferred in the range of 2 to 5 weight %, based on the total weight of the composition according to the invention.

Examples of suitable organic solvents are aromatic hydrocarbons, n-methylpyrrolidone, cresols, phenols, alcohols, styrenes, acetates, vinyl toluene, methyl acrylates, such as, e.g. 1-methoxy propyl acetate-2, n-butanol, n-propanol, butyl glycol acetate.

One or more monomeric organo-metallic compounds, such as, e.g., ortho-titanic or -zirconic acid esters as well as silanes, ethylsilicates, titanates, may be contained in the coating composition according to the invention. Preferably, such monomeric organo-metallic compounds are not used in the coating composition according to the invention.

The composition according to the invention may be produced by simply mixing the individual components together. For example, it is possible to produce a dispersion of at least binder resin of component A) by mixing the binder resin with water. The further components are then added, for example, with stirring, to produce a stable dispersion, optionally, with input of heat and dispersing agents. It is also possible to produce a mixture of the binder resin with further components of the composition and add a water-based dispersion of the nano scaled particles.

Application of the composition according to the invention can proceed in known manner, e.g., by spraying, rolling or dipping coating onto at least one, for example, one or all sides of the electrical steel sheets as at least one layer, for example, one or more layers, with a dry layer thickness of 0.5 to 10 μm, preferably, 0.8 to 8 μm, particularly preferred, 0.8 to 6 μm per layer.

The surface of the electrical steel sheet sides may be pre-coated or uncoated, pretreated or un-pretreated. The sheets may be pretreated, for example, by washing in order to remove soiling, grease and other deposits. Preferred pre-washed and uncoated electrical steel sheets are used, coated with the composition according to the invention, preferably by a one-layer-coating.

Subsequently the crosslinking (curing) of the coating of the invention on the steel sheet takes places by thermal curing under definite curing conditions, preferably, at temperatures providing a PMT (peak metal temperature) in the range of 180 to 270° C. The necessary heat can be supplied, for example, in an oven, by means of induction heating, infrared (IR) radiation, near infrared (NIR) radiation and/or hot air.

Therefore, this invention provides also a process of coating electrical steel sheets comprising the steps
a) applying the coating composition of the invention onto at least one side of the electrical steel sheets as at least one layer, and
b) curing the applied coating.

After curing, parts can be punched out of the coated steel sheet and can then be stacked and assembled to form a sheets core by different technical means such as welding, clamping, interlocking, aluminium die casting or riveting, if necessary, by supply of heat and pressure.

Therefore, this invention also provides a process of preparation an electrical steel sheets core by stacking and assembling of electrical steel sheets, the steel sheets coated with the coating process of this invention.

The composition according to the invention makes it possible to ensure a long service life of electrical equipment, such as, motors, transformers, generators.

The present invention is further defined in the following Examples. It should be understood that these Examples are given by way of illustration only. As a result, the present invention is not limited by the illustrative examples set forth herein below, but rather is defined by the claims contained herein below.

### EXAMPLES

### Example 1 to 6

Manufacture of Coatings According to the Invention Based on a C5 Electrical Insulation Varnish

An aliphatic polyurethane dispersion (solid content of 34-40 weight % in water) is mixed with a dispersion of nano scaled silica (solid content of 35-40 weight % in alkaline water). The cross-linking agent (solid content of 35-100 weight %), pigments, fillers and additives are added to this mixture, wherein 0.5 to 1.5 parts per weight of coated silica-gel as welding additive, 0 to 3 parts per weight of a aminocarboxy compound as corrosion inhibitor additive and 0 to 2 parts per weight of a defoamer additive are used. The mixture is stirred homogeneous to provide six different coating compositions of the invention as a C5 varnish with different cross-linking agents. The coating compositions are described in Table 1. The amounts are in parts per weight.

TABLE 1

| | | | Cross-linking agent | | | | | | |
|---|---|---|---|---|---|---|---|---|---|
| | Polyurethan | Silica | | | Melamine | Epoxy | Triethanolamine | Pigment/ | |
| | dispersion | dispersion | Carbodiimid | Aziridine | resin | resin | Zirconate | Filler | Additives |
| Example 1 | 50 | 50 | 1 | | | | | 1.5 | 5 |
| Example 2 | 50 | 50 | 5 | | | | | 1.5 | 5 |
| Example 3 | 70 | 30 | | 2 | | | | 1.5 | 5 |
| Example 4 | 56 | 30 | | | 14 | | | 1.5 | 5 |
| Example 5 | 50 | 50 | | | | 1 | | 1.5 | 5 |
| Example 6 | 55 | 30 | | | | | 15 | 1.5 | 5 |

Each coating composition listed in Table 1 is coated on different grades of non-oriented steel to form an insulation layer with dry film-thickness of 1 μm (+/−0.5). The steel sheets roughness Ra of 0.5 μm or less was used. A roller-coater was used to apply the varnish on steel sheet. The applied film was cured at a PMT (peak metal temperature) of 200° C. to 260° C. and cooled at room temperature.

After curing the coated steel sheets are stacked and assembled by welding to form a sheets core.

The technical properties compared to the prior art are described in Table 2.

TABLE 2

| | Example | | | | | | |
|---|---|---|---|---|---|---|---|
| | | | | | | | Prior Art |
| | | | | | | | Example 16 |
| Coating properties | 1 | 2 | 3 | 4 | 5 | 6 | (Reference) |
| 1. Dry coating thickness [μm] | 0.5 to 3 | 0.5 to 3 | 0.5 to 3 | 0.5 to 3 | 0.5 to 3 | 0.5 to 3 | 0.5 to 2 |
| 2. Curing speed [sec] | 30 | 25 | 20 | 35 | 25 | 35 | 35-40 |
| (Mathis oven at temperatur 300° C. | | | | | | | |
| PMT 200° C. to 250° C.) | | | | | | | |
| 3. Solvent stability 30 times with | ok | ok | ok | ok | ok | ok | ok |
| acetone and ethanole | | | | | | | |
| 4. Adhesiveness with conical mandrel | 3 mm | 3 mm | 3 mm | 3 mm | 3 mm | 3 mm | 3 mm |
| ISO 6860 | | | | | | | |
| 5. Scratch resistance at 2 μm in [%] | 100 | 100 | 100 | 95 | 100 | 95 | 80 |
| ISO 1518 | | | | | | | |
| 6. Corrosion resistance-Salt spray test | <20 | <20 | <20 | <30 | <20 | <30 | <40 |
| DIN EN ISO 9227 | | | | | | | |
| Evaluation of corrosion surface [%] on | | | | | | | |
| 1 μm film thickness after 6 h | | | | | | | |
| 7. Surface insulation resistance | 18 to 22 | 18 to 22 | 20 to 25 | 10 to 15 | 20 to 25 | 15 to 20 | 4 to 11 |
| [Ohm cm²/L (1 μm) | | | | | | | |
| ASTM A 717-06 | | | | | | | |
| 8. Surface insulation after Annealing | 7 to 13 | 7 to 13 | 3 to 9 | 3 to 9 | 7 to 13 | 3 to 9 | 2 to 8 |
| DIN IEC 60404-12 | | | | | | | |
| 9. Abrasion resistance under 5 kg | <1.0 | <1.0 | >1.0 | >1.0 | <1.0 | >1.0 | >1.5 |
| pressure [mg] | | | | | | | |
| 10. Interlocking performance [%] | 100 | 100 | 100 | 100 | 100 | 100 | 90 |
| 11. Welding (TIG) SEP 1210 | 100 | 100 | 100 | 90 | 100 | 100 | 80 |
| Pressure: 160 N/cm²; | | | | | | | |
| speed: 600 mm/min | | | | | | | |
| bubble-free/no soot = 100% | | | | | | | |
| 3-4 bubbles/no soot = 90% | | | | | | | |
| 3-4 bubbles/soot = 80% | | | | | | | |

In line 3, the solvent stability is tested by a wiping solvent test with a pressure of 1 kg by double rub until 30 double rubs have been completed. The acetone solvent test also indicated the curing characteristics of the dried film. In line 9, the abrasion resistance was measured with an abrasion tester designed by DuPont, by determination of dust quantity of the coated steel sheets under 5 kg pressure within 30 double rubs. In line 11, the quality of welding is given by bubble free and soot-free seam according to the steel-and-iron test sheet SEP 1210.

### Example 7 to 10

Manufacture of Coatings According to the Invention Based on a C6 Electrical Insulation Varnish

The manufacture process is the same as described under Examples 1-6. The mixture is stirred and grinded homogeneously.

The compositions of C6 varnishes with different cross-linking agents are described in Table 3. The amounts are in parts per weight.

TABLE 3

| | | | Cross-linking Agent | | | | | |
|---|---|---|---|---|---|---|---|---|
| | Polyurethan | Silica | | | Melamine | Epoxy | | |
| | dispersion | dispersion | Carbodiimid | Aziridine | resin | resin | Pigment/Filler | Additives |
| Example 7 | 36 | 3 | 1 | | | | 58 | 5 |
| Example 8 | 36 | 3 | | 1 | | | 58 | 5 |
| Example 9 | 34 | 3 | | | 3 | | 58 | 5 |
| Example 10 | 36 | 3 | | | | 1 | 58 | 5 |

The coating compositions as indicated in Table 3 are applied and cured on electrical steel sheets by the same methods and conditions as described under Examples 1-6 to form an insulation layer with a dry film-thickness of 6 μm (+/−0.7). After curing, the coated steel sheets are stacked and assembled by welding to form a sheets core.

The technical properties compared to the prior art are described in Table 4.

TABLE 4

| | Example | | | | |
|---|---|---|---|---|---|
| | | | | | Prior Art |
| | | | | | Example 17 |
| Coating properties | 7 | 8 | 9 | 10 | (Reference) |
| 1. Dry coating thickness [μm] | 3 to 10 | 3 to 10 | 3 to 10 | 3 to 10 | 3 to 8 |
| 2. Curing speed [sec] | 30 | 20 | 35 | 30 | 35 |
| (Mathis oven at temperatur 300° C. | | | | | |
| PMT 200° C. to 250° C.) | | | | | |
| 3. Solvent stability 30 times with acetone and ethanole | ok | ok | ok | ok | ok |
| 4. Adhesiveness with conical mandrel ISO 6860 | 3 mm | 3 mm | 3 mm | 3 mm | 3 mm |
| 5. Scratch resistance at 6 μm in [%] | 100 | 100 | 95 | 100 | 80 |
| ISO 1518 | | | | | |
| 6. Corrosion resistance-Salt spray test DIN EN ISO | <20 | <20 | <30 | <20 | <40 |
| 9227 | | | | | |
| Evaluation of corrosion surface [%] on 6 μm film | | | | | |
| thickness after 24 h | | | | | |
| 7. Surface insulation resistance | 1500 | 1500 | 1500 | 1500 | 1500 |
| ASTM A 717-06 [Ohmcm²/L] at 6 μm | | | | | |
| 8. Overcoatability [%] | 100 | 100 | 100 | 100 | 100 |
| 9. Pressure stability (Stack-shrinkage 160° C./500 h) | <0.4% | <0.4% | <0.6% | <0.6% | <0.7% |
| 10. Burn-off repair | ok | ok | ok | ok | ok |

### Example 11 to 14

Manufacture of Coatings According to the Invention Based on a C3 Electrical Insulation Varnish

The manufacture process is the same as described under Examples 1-6.

The compositions of C3 varnishes with different cross-linking agents are described in Table 5. The amounts are in parts per weight.

TABLE 5

| | | | Cross-linking Agent | | | | | |
|---|---|---|---|---|---|---|---|---|
| | Polyurethan | Silica | | | Melamine | Epoxy | Pigment/ | |
| | dispersion | dispersion | Carbodiimid | Aziridine | resin | resin | Filler | Additive |
| Example 11 | 90 | 10 | 2 | | | | 1.5 | 5 |
| Example 12 | 90 | 10 | | 1 | | | 1.5 | 5 |
| Example 13 | 75 | 10 | | | 8 | | 1.5 | 5 |
| Example 14 | 90 | 10 | | | | 3 | 1.5 | 5 |

The coating compositions as indicated in Table 5 are applied and cured on electrical steel sheets by the same methods and conditions as described under Examples 1-6 to form an insulation layer with a dry film-thickness of 4 μm (+/−0.4). After curing, the coated steel sheets are stacked and assembled by welding to form a sheets core.

The technical properties compared to the prior art are described in Table 6.

TABLE 6

| | Example | | | | |
|---|---|---|---|---|---|
| | | | | | Prior Art |
| | | | | | Example 15 |
| Coating properties | 11 | 12 | 13 | 14 | (Reference) |
| 1. Dry coating thickness [μm] | 0.5 to 4 | 0.5 to 4 | 0.5 to 4 | 0.5 to 4 | 0.5 to 4 |
| 2. Curing speed [sec] | 30 | 20 | 35 | 25 | 35-40 |
| (Mathis oven at temperatur 300° C. | | | | | |
| PMT 200° C. to 250° C.) | | | | | |
| 3. Solvent stability 30 times with | ok | ok | ok | ok | ok |
| acetone and ethanole | | | | | |
| 4. Adhesiveness with conical mandrel | 3 mm | 3 mm | 3 mm | 3 mm | 3 mm |
| ISO 6860 | | | | | |
| 5. Scratch resistance at 3 μm in [%] | 100 | 100 | 100 | 100 | 80 |
| ISO 1518 | | | | | |
| 6. Corrosion resistance-Salt spray test | <30 | <30 | <40 | <30 | <50 |
| DIN EN ISO 9227 | | | | | |
| Evaluation of corrosion surface [%] on | | | | | |
| 3 μm film thickness after 24 h | | | | | |
| 7. Surface insulation resistance | >70 | >70 | >70 | >70 | >50 |
| [Ohm cm²/L] at 3 μm | | | | | |
| ASTM A 717-06 | | | | | |
| 8. Punchability | excellent | excellent | excellent | excellent | excellent |
| 9. Welding SEP 1210 (3 μm) | 90 | 100 | 80 | 80 | <80 |
| Pressure: 160 N/cm²; | | | | | |
| speed: 600 mm | | | | | |
| bubble free/no soot = 100% | | | | | |
| 3-4 bubbles/no soot = 90% | | | | | |
| 3-4 bubbles/soot = 80% | | | | | |

### Example 15

Manufacture of Coating According to Prior Art Based on a C3 Electrical Insulation Varnish

48 parts per weight of acrylate resin dispersion (solid content 41 weight % in mixture of water and organic solvent) and 7 parts per weight alkyd resin dispersion (solid content of 68 weight % in mixture of water and organic solvent) are mixed together with 12 parts per weight of melamine resin as cross-linking agent (solid content of 99 weight %). 1 to 6 parts per weight of additives (defoamer, wetting agent, corrosion inhibitor) and 26 parts per weight of butyl propylene glycol as organic solvent and/or water are added. Dimethylethanolamine is used to adjust the pH-value of the mixture. The mixture is stirred and grinded homogeneous.

The resulted coating composition is applied and cured on electrical steel sheets by the same methods and conditions as described in Example 11-14.

After curing, the coated steel sheets are stacked and assembled by welding to form a sheets core, see Table 6.

### Example 16

Manufacture of Coating According to Prior Art Based on a C5 Electrical Insulation Varnish

21 parts per weight of titanate resin (solid content of 75 weight % in mixture of water and organic solvent) and 16 parts per weight of acrylate resin (solid content of 75 weight % in mixture of water and organic solvent) are mixed with 10 parts per weight aluminium silicate as inorganic filler (solid content of 100 weight %) and 4 parts per weight of metal catalyst as cross-linking agent (solid content of 100 weight %). 4 parts per weight of additives (defoamer, wetting agent, welding additive and corrosion inhibitor) and 45 parts per weight of butyl diglycol as organic solvent and/or water are added. Dimethylethanolamine is used to adjust the pH-value. The mixture is stirred and grinded homogeneous.

The resulted coating composition is applied and cured on electrical steel sheets by the same methods and conditions as described in Example 1-6. After curing, the coated steel sheets are stacked and assembled by welding to form a sheets core, see Table 2.

### Example 17

Manufacture of Coating According to Prior Art Based on a C6 Electrical Insulation Varnish

20 parts per weight of alkyd resin (solid content of 68 weight % in a mixture of water and organic solvent) are mixed with 55 parts per weight barium sulphate as inorganic filler and 5 parts per weight of melamine resin as cross-linking agent (solid content of 99 weight %). 6 parts per weight of additives (defoamer, catalyst, wetting agent, corrosion inhibitor) and 2 parts per weight of pigment as well as 7 parts per weight of butyl propylene glycol as organic solvents and/or water are added. Dimethylethanolamine is used to adjust the pH-value. The mixture is stirred and grinded homogeneous.

The resulted coating composition is applied and cured on electrical steel sheets by the same methods and conditions as described in Example 7-10. After curing, the coated steel sheets are stacked and assembled by welding to form a sheets core, see Table 4.

The test results shows better results for the sheets and sheets cores coated with the composition according to the invention compared to the prior art, in particular, higher scratch resistance, surface insulation resistance, abrasion resistance and a higher ability for welding.

What is claimed is:

1. A coating composition to coat electrical steel sheets, the composition comprising:
A) 5 to 45 weight % of at least one binder resin,
B) 0.1 to 40 of nano scaled particles, the particles having an average radius ranging from 1 to 300 nm,
C) at least one cross-linking agent in an amount able to cross-link with the binder resin,
D) 0.1 to 60 weight % of at least one additive and/or pigment and/or filler, and
E) 5 to 70 weight % of water and/or at least one solvent, the weight % based on the total weight of the composition.

2. The coating composition of claim 1 comprising 1 to 30 weight % of the nano scaled particles.

3. The coating composition of claim 1 comprising 0.1 to 30 weight % of the at least one cross-linking agent.

4. The coating composition of claim 1 wherein the binder resin of component A is selected from the group consisting of polyurethanes, poly(meth)acrylates and mixtures thereof.

5. The coating composition of claim 1 wherein the nano scaled particles having an average radius ranging from 5 to 60 nm.

6. The coating composition of claim 1 wherein the nano scaled particles are selected from the group consisting of silica, aluminium oxide and titanium oxide.

7. The coating composition of claim 1 wherein solvent is used in the range of 1 to 10 weight % based on the total weight of the composition.

8. A process of coating electrical steel sheets comprising the steps
a) applying the coating composition of claim 1 onto at least one side of the electrical steel sheets as at least one layer, and
b) curing the applied coating.

9. The process of claim 8 wherein the applied coating is cured at temperatures providing a PMT (peak metal temperature) in the range of 180 to 270° C.

10. A process of preparation an electrical steel sheets core by stacking and assembling of electrical steel sheets, the steel sheets coated according to the process of claim 8.

11. The process of claim 10 wherein stacked and assembled electrical steel sheets are welded to form the core.

12. An electrical steel sheet coated with the coating composition of claim 1 and curing the coating.

13. An electrical steel sheets core prepared from electrical steel sheets coated with the coating composition of claim 1 and curing the coating.
